(19) United States
(12) Patent Application Publication
(10) Pub. No.: US 2008/0278469 A1
(43) Pub. Date: Nov. 13, 2008

(54) Display Panels Driving Apparatus and Method

(76) Inventors: Gad Terliuc, Raanana (IL); Ronen Lin, Tel-Aviv (IL)

Correspondence Address: DANIEL J SWIRSKY, 55 REUVEN ST., BEIT SHEMESH, 99544, IL

(21) Appl. No.: 12/092,576

(22) PCT Filed: Nov. 13, 2006
(86) PCT No.: PCT/IL06/01301

§ 371 Date: May 4, 2008

Related U.S. Application Data
(60) Provisional application No. 60/735,893, filed on Nov. 14, 2005.

(51) Int. Cl. G09G 5/00

(52) U.S. Cl. 345/209

(57) ABSTRACT

A device such as a smart card (100) capable of displaying data on a display panel (122). The panel (122) comprises an array of segments (130) coupled to a battery (124) for activating any or several of the segments. Microprocessor (114) is employed for storing and processing data. Switch (110) is operable by the user. Driver (120) includes electronic switches (220; 222) for activating a selection of the segments in accordance with the processed data to display segmented symbols on the panel (122). In order to extend battery life while keeping long-lasting quality performance, the polarity of the voltage applied to the segments is reversed in succession with respect to the previous activations.

### FIELD OF THE INVENTION

This invention relates to display panels, and particularly to a method and apparatus of activation thereof. More specifically, the invention concerns visual display panels typically though not exclusively, liquid crystal based display (LCD) panels. The terms “LC” or “LCD” shall therefore be used throughout the present specification to include as well other types of display devices such as polymer dispersed liquid crystal (PDLC) displays, electro-phoretic display, electro-chromic displays, etc., as will become apparent in view of the description below. Still more specifically the invention is focused on the implementation of display panels in smart cards.

### BACKGROUND OF THE INVENTION

For reasons associated with the basic physics of LCD, it has been accepted as common practice to activate the LC individual segments, combinations of which compose an eligible alpha-numeric (characters or digits), or other symbols, by continued alternating (+) and (−) voltage pulses, typically square waves at frequency of 30-90 Hz (cycles per second). It has been experienced that driving the segments otherwise, namely by non-alternate pulses, or pulses at frequencies other than specified, will cause meaningful deterioration of the display performance over time, such as decreased contrast.

It is further known that voltage alternating frequency should preferably be higher than a human eye refresh rate, in order to prevent flickering of the display image during display activation. Therefore, LCD voltage is commonly alternating during display operation at rates higher than 25 Hz (cycles per second)

Alternate voltage (or current) feeding is relatively high energy consumption. Hence, for devices powered by small size batteries the use of LCD panels has been heretofore ruled-out.

### OBJECTS OF THE INVENTION

It is therefore the major object of the invention to provide a method of electrical driving of panels suitable for use in devices operated by low capacity batteries.

It is a further object of the invention to activate LCD segments by non-alternate pulses during their operational cycles.

It is a still further object of the invention to provide a driver circuit adapted to reverse the polarity of the voltage pulses applied to any given segment after every operational cycle thereof, thereby discharging any residual capacitance accumulated during the previous cycle.

It is a still further object to apply the present invention to what is known as “Smart Cards” namely, credit-card-like, data processing devices operable as OTP, e-purses, active identification cards and, others for applications as known in the art.

### SUMMARY OF THE INVENTION

According to one aspect of the invention there is provided a method of operating liquid crystal (as hereinbefore defined) display panels, comprising an array of segments drivingly coupled to DC power source, characterized in that the panel is intermittently activated for displaying information by applying a DC voltage pulse to a selection of segments comprised in said panel for given length of time and of a given polarity [(+) or (−)], and wherein during the next activation of the same selection of segments a similar DC voltage is applied but of a reverse polarity.

According to another aspect of the invention there is provided a device, such as “Smart Card”, comprising means for storing data, means for processing the stored data, electric power supply means selectively operable by a user, means for deactivating the power source after a pre-set period of time, a display panel, comprised of segments, and means for activating selected segments in accordance with the processed data to display segmented symbols by said panel, characterized by means for reversing the polarity [(+) or (−)] of the activating means in succession with respect to every cycle of activation.

### BRIEF DESCRIPTION OF THE DRAWINGS

These and additional constructional features and advantages of the invention will be more readily understood in the light of the ensuing description of a preferred embodiment thereof, given by way of example only, with reference to the accompanying drawings, wherein:—

FIG. 1 is a schematic representation of a smart card constructed and operative in accordance with an embodiment of the present invention;

FIG. 2 is a block diagram of the smart card of FIG. 1 after a first given activation thereof;

FIG. 3 is a block diagram of the smart card of FIG. 2 after an activation subsequent to the activation of FIG. 2;

FIG. 4 is a voltage vs. time diagram of the operational cycles.

FIG. 5 is a general block diagram of a driver according to a preferred embodiment of the invention;

FIG. 6 is schematic representation of the switching array of FIG. 5 operatively connected to a group of segments; and

FIGS. 7a and 7b are schematic representations of positive and negative polarity activation modes of the segments of FIG. 6, respectively.

### DETAILED DESCRIPTION OF THE PREFERRED EMBODIMENT

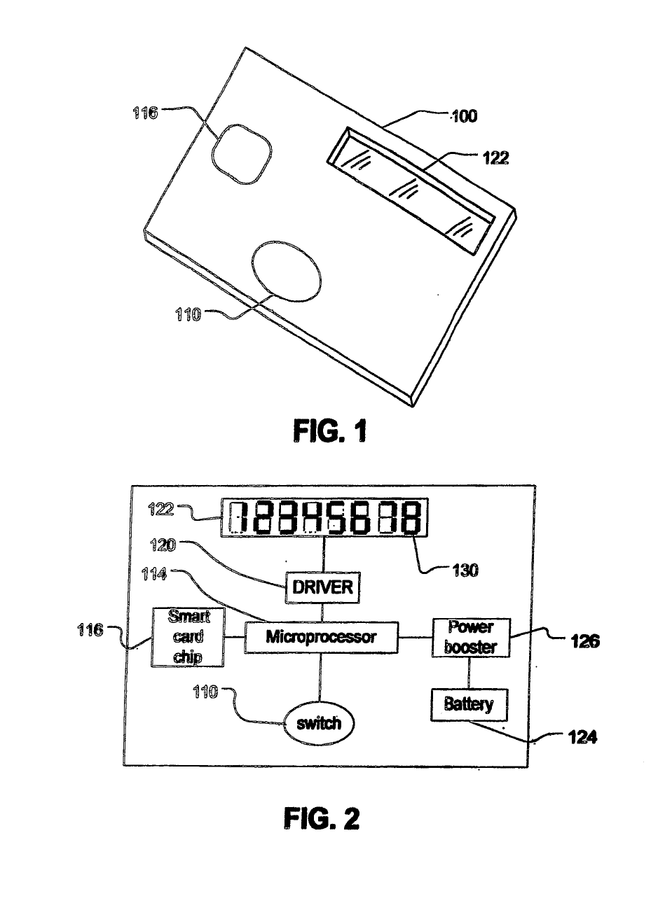

As shown in FIG. 1 the smart card generally denoted 100 is of a regular plastic credit card size and shape, normally 1.2 ₘₘ or less thick. It comprises a display panel 122, an embedded operating switch 110 and, optionally, smart-card chip 116 for downloading data from external sources.

Referring to FIG. 2, a user wishing to obtain, e.g. alpha-numeric data through the display panel 122, may operate switch 110, thereby a signal is transmitted to a microprocessor 114, which preferably stores data that was previously retrieved during connection of the smart card chip 116 to an external reader or an ATM machine, or any other suitable sources. Alternatively, microprocessor 114 may retrieve data stored in the smart card chip 116 upon pressing on switch 110.

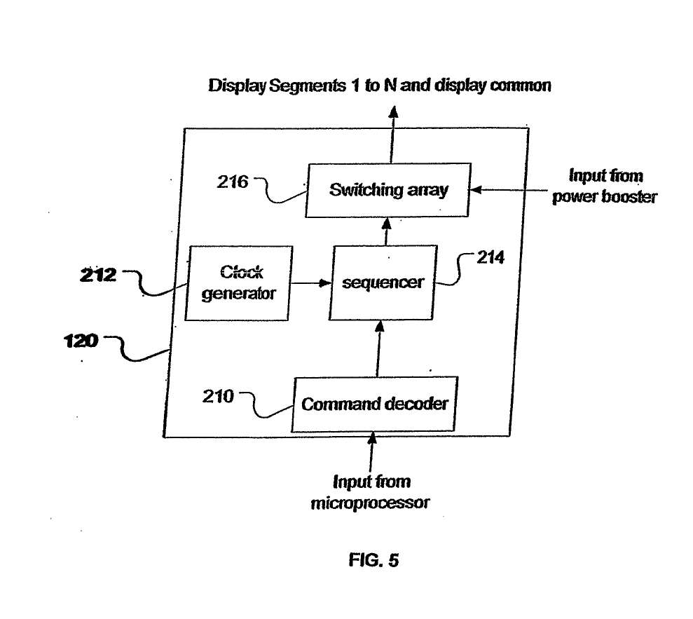

The microprocessor 114 communicates with a display driver 120 (details of which are given below with reference to FIGS. 5-7) which, in turn, communicates with the display panel 122 for displaying the requested or available information. Such information may commonly be presented by a digital alpha-numerical display but may also be presented by a cartographical, matrix or any other pictorial display depending of the application.

In the example of FIG. 2, the data displayed on display panel 122 is an authentication number of a user. Any other data may be displayed, such as a telephone number, an identification number, banking information and bank account data, or a one-time password (OTP) for card holding authentication in telephone or internet credit card transactions. Different types of information and data may be provoked by successive pressing the switch 110. This data may be used, for example, for an ill patient suffering from a disease involving memory loss, such as Alzheimer. The data may be used to aid an ill patient, in times of memory loss, in retrieving important personal information.

In the case of a banking smart card, the display may present financial information, such as an account balance, the last transaction, or any other suitable information. It is appreciated that various types of information may be visualized alternately on display panel 122, through successive pressing actions on switch 110 and/or by employing more than one switch.

It is appreciated that the smart card 100 may be used for any suitable purpose, besides storing financial data and medical data, or generating OTP.

Power is supplied to the smart card 100 via a battery 124 mostly of the dry-cell type, which is preferably embedded in the smart card 100. A power booster 126 may be utilized in conjugation with battery 124, to increase or decrease the battery voltage, thereby supplying power with suitable electrical voltage to the display panel 122 via the display driver 120, which supplies an operating voltage to appropriate segments of display panel 122, so as to display information on the display panel 122.

The display panel 122 may be any suitable display, as well known in the art. Typically, the display panel 122 may be a capacitive, non bi-stable display, i.e. a display in which suitable voltage is applied to the activate segments and continuously charge them in order for the information to be displayed. Examples for capacitive and non bi-stable displays are liquid crystal displays (LCD) or polymer dispersed liquid crystal displays (PDLC).

It is known that capacitive, non bi-stable displays, typically, cannot withstand long-term DC voltage, and therefore the polarity of the charging voltage is alternated during a display operation period, i.e. the period of operation of the display panel 122 in which information is continually displayed on the display panel 122.

In conventional driving schemes, generally, the polarity of the electric voltage is alternated sequentially during the display operation period (AC voltage). In the present invention the segments of the display panel 122 are charged by direct voltage (DC voltage) without alternating the voltage polarity during the entire display operation period. It is appreciated that in the case of the present invention, the display panel 122 displays information for a relatively short period of time, either pre-determined by the microprocessor 114 or governed by the pressing period on the switch 110. A typical such display operation period may be in the range of 10 to 60 seconds. The display panel 122 may shut off between such short display operation periods, in order to save power of the battery 124.

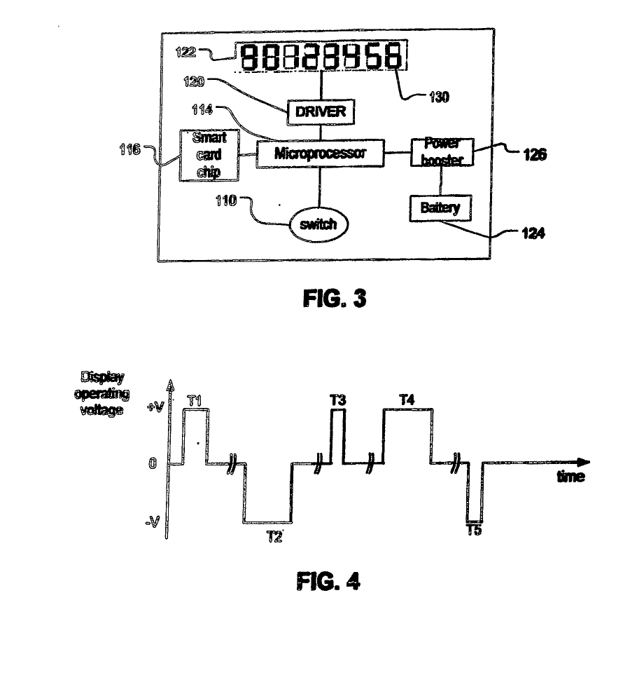

It is a particular feature of the present invention that the charging polarity of the DC voltage alternates upon different display operation periods of the display panel 122 of smart card 100, and preferably upon successive display operation periods of the display panel 122 of smart card 100. For example, as seen in FIG. 4, during a display operation period T1, which corresponds to display operation of the smart card 100 in FIG. 2, the DC voltage polarity is constantly positive. Upon subsequent display operation of the smart card 100 (after a shut-off period), as shown in FIG. 3, the DC voltage polarity is constantly negative, as seen in a subsequent display operation period T2, which corresponds to the display operation of the smart card 100 in FIG. 3. As seen in FIG. 4, the DC voltage polarity is alternated to positive in operation period T3, remains positive in subsequent operation period T4, and then alternated to negative polarity in operation period T5. It is appreciated that any suitable sequence of positive and negative DC voltage polarities may be practiced, as preferred and as predetermined by the microcontroller 114. Preferably, the polarity of the DC voltage may alter staggeredly, namely upon each subsequent display activation of the smart card 100.

It is appreciated that a substantial portion of the display operation power, supplied by the battery 124 through power booster 126, may be consumed by the charging operation of the appropriate display segments. Thus, use of power provided by the battery 124 is significantly reduced through the DC voltage alternating polarity operation scheme described herein above with reference to FIG. 4, since the charging polarity is constant during a single display operation period, wherein if the polarity would alternate once or more during a single display operation period of the smart card 100, the use of power would significantly be increased due to increased number of charging and discharging events of the display segments, typically capacitive segments, of display panel 122.

It is appreciated that the charging polarity at the initial operation of the smart card 100 may be negative or positive.

Accumulation of a net DC voltage on the segments of the display panel 122, caused by the constant polarity during a single display operation period or cycle of the smart card 100, is typically and statistically diminished or fully annulled upon many subsequent operations of the smart card 100. This can be seen by observing the group of segments operated in the display panel 122 and designated by reference numeral 130 in FIGS. 2 and 3. As seen in FIG. 4, the polarity during T1 is positive, thus the charge accumulated on segments 130 is positive. In a subsequent operation of the smart card 100, as shown in FIG. 3, the polarity during T2 is negative thus the net DC voltage on that segments, here designated by the reference numeral 132 in FIG. 31 is minimized and balanced, and may even be fully annulled.

Thus, upon a multiplicity of operations of the smart card 100 the DC charge accumulation is substantially minimized or even eliminated by being statistically neutralized by discharge so as to achieve negligible net DC effect.

Preferably, the display time durations (T₁, T₂, T₃, . . . Tₙ) may be constant. Alternatively, time durations may be different from each other, in which case that difference may preferably be random. Yet alternatively, the time operation periods of display 122 may be different, but such that over a large number of operation periods the overall time of positive DC voltage operation will be similar to the overall time of negative DC voltage operation.

Preferably, the polarity of the DC voltage is alternated in every operation period. Alternatively, the polarity of the DC voltage may be alternated randomly, or according to a pre-determined sequence that balances the number of positive and negative operation periods over a large number of operation periods.

It is appreciated that charge neutralizing may occur over long term operation of the display, and over a large number of operating periods According to the operation conditions as described herein above, the probability of any segment of display 122 (such as, for example, segments 130 in FIG. 2) to be operated by a positive or negative voltage polarity over a large enough number of operation periods is similar, and the accumulative positive DC voltage time and negative DC voltage time of that segment (such as segments 130 in the above mentioned example) are substantially balanced, or even cancelled.

Reference is now made to FIG. 5, which is a simplified block diagram of a display driver constructed and operative in accordance with an embodiment of the present invention. As seen in FIG. 5, display driver 120 of FIGS. 2-3 is generally comprised of a command decoder 210, a clock generator 212, a sequencer 214 and a switching array 216.

The command decoder 210 interprets the commands received from the microprocessor 114 and initializes the operation of the sequencer 214 accordingly.

The clock generator 212 generates the timely pulses required for synchronizing the data transmission to the display, as commonly practiced in the art. Sequencer 214 transforms the input received from the command decoder 210 to a vector of binary signals corresponding to the segments and common plane of display panel 122 and transmit that vector of signals to the switching array 216, which switches the individual segments and common plane of display 122 accordingly to either ground voltage or to positive voltage received from the power booster 126.

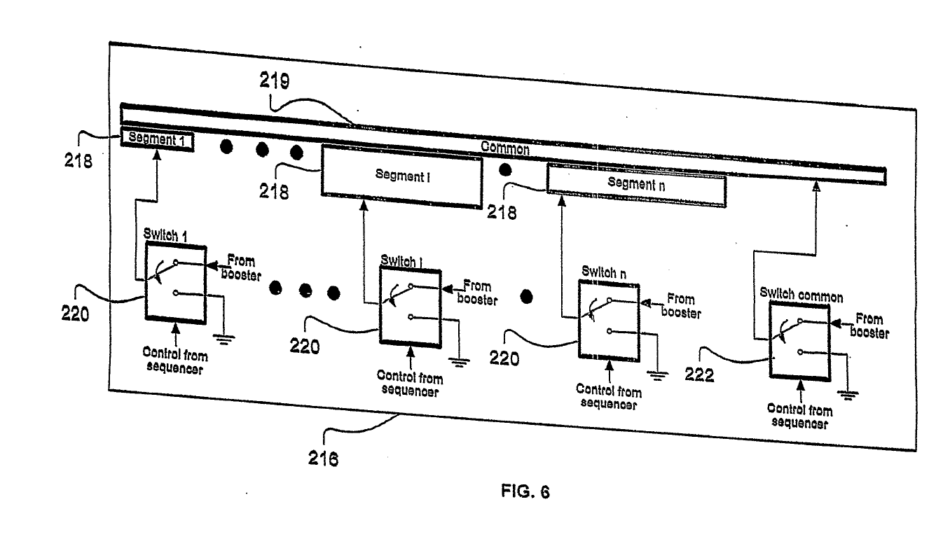

Reference is now made to FIG. 6, which is a simplified block diagram of the switching array 216 of FIG. 5, constructed and operative for driving a segmented display having a number n of segments 218 and a common plane 219 which is underlying all n segments, as well known in the art. As seen in FIG. 6, the switching array 216 is comprised of a number n of two-state electronic switches 220, each of which is in electrical communication with a single segment of the n segments of display 122, and a two-state electronic switch 222 in electrical communication with the common plane of display 122. As seen in FIG. 6, each of switches 220 and 222 receives an appropriate electronic signal from sequencer 214, and switches the output voltage for the respective segment or common accordingly, to either ground voltage or positive DC voltage received from the power booster 126. Hence, each of the n display segments and display common plane accommodates, in each operation period, either ground (zero) voltage or DC positive voltage as dictated by the driver 120.

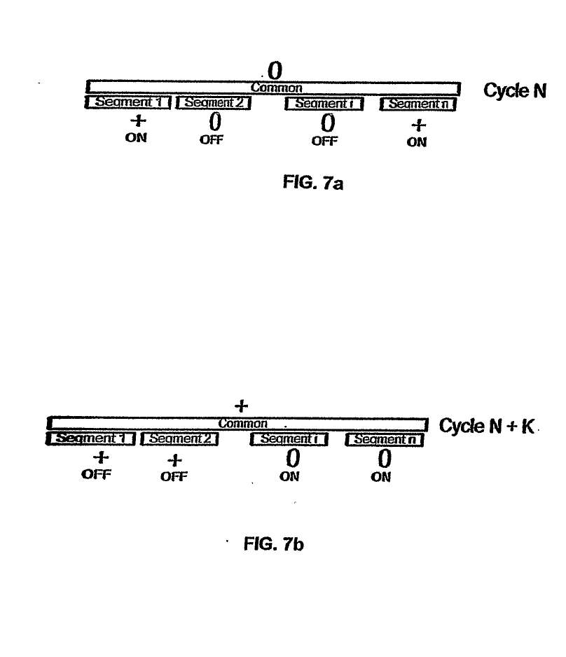

Reference is now made to FIGS. 7a and 7b, which are simplified schematic illustrations of few of segments 218 and common plane 219 of display 122, in two DC voltage operative state examples. FIG. 7a demonstrates an example of the DC voltage configuration of few segments 218 and of common plane 219 during an operation period number N, as generated by driver 120 as detailed herein above with reference to FIG. 5 and FIG. 6. FIG. 7b demonstrates an example of the DC voltage configuration of few segments 218 and of common plane 219 during an operation period number N+K, as generated by driver 120 as detailed herein above, with reference to FIG. 5 and FIG. 6.

In the example of FIG. 7a, the segments numbered 1 and n assume positive DC voltage, while the segments numbered 2 and i and the common plane 219 assume ground (zero) voltage. As a consequence, during that operation period (number N), segments 1 and n exhibit DC voltage difference there-across and are activated while segments 2 and i exhibit zero voltage difference there-across and are not activated. Yet as a consequence, the polarity of the DC voltage across the activated segments 1 and n is positive, namely the segment 218 assumes a higher voltage than the common plane 219.

In the example of FIG. 7b, the segments numbered 1 and 2 and the common plane 219 assume positive DC voltage, while the segments numbered i and n assume ground (zero) voltage. As a consequence, during that operation period (number N+K), segments i and n exhibit DC voltage difference there-across and are activated while segments 1 and 2 exhibit zero voltage difference there-across and are not activated. Yet as a consequence, the polarity of the DC voltage across the activated segments i and n is negatives namely the common plane 219 assumes a higher voltage than the segment 218.

As demonstrated by FIGS. 7a and 7b, through the utilization and switching of either ground (zero) or positive DC voltage, the driver 120 can activate each of the individual segments 218 of display 122 by DC voltage of either positive or negative polarity.

It is appreciated that the method of polarity alternation upon display operation period may be employed in any suitable type of display and for any type of data storage means and driving methods.

It will be appreciated by persons skilled in the art that the present invention is not limited by what has been particularly shown and described herein above. Rather the scope of the present invention includes both combinations and subcombinations of the various features described hereinabove as well as variations and modifications which would occur to persons skilled in the art upon reading the specifications and which are not in the prior art.

1-37. (canceled)

38. A method of operating data display panels, the panels having an array of segments coupled to a DC power source for activating any or several of the segments, the method comprising the steps of:
activating a selection of said segments by applying thereto a DC voltage of either a positive or a negative polarity;
maintaining said applied voltage for a given duration of time;
deactivating said selection of segments; and
activating a selection of segments by a DC voltage of polarity opposite to the polarity of a previous activation.

39. The method according to claim 38, wherein the change of polarity occurs with respect to the immediately previous activation.

40. The method according to claim 38, wherein the time durations of said activations are constant.

41. The method according to claim 38, wherein the magnitude of the voltage applied during said activations is constant.

42. The method according to claim 38, wherein the display panel is of a capacitive and non-bi-stable type.

43. The method according to claim 42, wherein the display panel is of the liquid crystal type.

44. The method according to claim 38, and wherein said display is embedded in a plastic card.

45. An electronic device comprising:
a display panel operative for displaying visual information and having an array of display segments disposed thereof; and
a data storage and processing means operative for processing data and displaying data on said display panel, said data storage and processing means being operative for operating segments of said display panel both by applying a positive-polarity DC voltage there-across and by applying a negative-polarity DC voltage there-across.

46. The device according to claim 45, and wherein said data storage and control means is further operative for activation of a group of said segments for a given time duration, and deactivation of said group of segments thereafter.

47. The device according to claim 46, and wherein said data storage and processing means further comprises means for applying a positive-polarity DC voltage across said groups of segments during part of said activation steps, and for applying a negative-polarity DC voltage across said groups of segments during another part of said activation steps.

48. The device according to claim 46, wherein said data storage and processing means comprises a microprocessor operatively connected to said display panel via an electronic driver, the electronic driver comprising:
a series of electronic switches each connected to one respective segment of said display panel;
an electronic switch connected to said common plane of said display panel; and
means for controllably connecting said electronic switches to either positive DC voltage or ground voltage in accordance with said electronic device operation.

49. A device capable of displaying data on a display panel, the panel having an array of segments adapted to become activated by application of positive or negative DC voltage there-across, the device comprising:
means for storing and processing data;
means selectively operable by a user to activate the display of segmented symbols representing said data;
means for deactivating the display of the data after a pre-set period of time; and means for reversing the positive or negative polarity of the applied voltage in succession with respect to a previous activation.

50. The device according to claim 49, wherein said data storing and processing means comprise a microprocessor operatively connected to said panel via driver means, the driver means comprising:
a series of first two-state switching devices each connected to one pole of each segment;
a second two-state switching device connected to all other poles of the segments thus defining a common plane of the array of segments; and
means for controllably connecting the switching devices to either the positive DC voltage or zero DC voltage in accordance with the data processing means.

51. The device according to claim 50, further comprising command detector means and clock generator means operatively connected to sequencer means, the sequencer means being operable to operate each of the said first switching devices and said second switching device in accordance with the processed data to display segmented symbols thereof by the display panel.

52. The device according to claim 51 being in the form, size and shape of a plastic credit card.
